(19) United States
(12) Patent Application Publication
(10) Pub. No.: US 2021/0284100 A1
(43) Pub. Date: Sep. 16, 2021

(54) VEHICLE SAFETY SYSTEM

(71) Applicant: ZF FRIEDRICHSHAFEN AG, Friedrichshafen (DE)

(72) Inventors: VENKATESWARA ADUSUMALLI, New Hudson, MI (US); ROBERT BERG, Ann Arbor, MI (US); SANTANU PANJA, Commerce Township, MI (US); JAMES OLDIGES, Farmington Hills, MI (US); SRIHARSHA YELURI, Farmington Hills, MI (US); RADHA SIVARAMAN, Troy, MI (US)

(21) Appl. No.: 16/816,397

(22) Filed: Mar. 12, 2020

(51) Int. Cl. B60R 25/31; B60R 25/30; B60R 25/34; B60R 25/10; G07C 5/00; G06K 9/00

(52) U.S. Cl. CPC B60R 25/31; B60R 25/305; B60R 25/34; B60R 25/1012; B60R 2300/8006; G06K 9/00832; G06K 9/00791; B60R 2025/1016; G07C 5/008

(57) ABSTRACT

A method of monitoring a vehicle includes determining the vehicle is in a parked condition and unoccupied. Images of the unoccupied vehicle are acquired. At least one of the acquired images is sent to a user of the vehicle in response to detecting an individual at the unoccupied vehicle.

### TECHNICAL FIELD

The present invention relates generally to vehicle assist systems, and specifically to a safety system for a vehicle.

### BACKGROUND

Current driver assistance systems (ADAS—advanced driver assistance system) offer a series of monitoring functions in vehicles. In particular, the ADAS can monitor the environment within or around the vehicle and notify the driver of the vehicle of conditions therein or surrounding the vehicle. To this end, the ADAS can capture images of the vehicle interior or exterior and digitally process the images to extract information. The vehicle can perform one or more functions in response to the extracted information.

### SUMMARY

In one example, a method of monitoring a vehicle includes determining the vehicle is in a parked condition and unoccupied. Images of the unoccupied vehicle are acquired. At least one of the acquired images is sent to a user of the vehicle in response to detecting an individual at the unoccupied vehicle.

In another example, a method of monitoring a vehicle includes determining the vehicle is in a parked condition and unoccupied. At least one unsecure condition of the vehicle is identified. The user is notified of the at least one unsecure condition.

Other objects and advantages and a fuller understanding of the invention will be had from the following detailed description and the accompanying drawings.

### BRIEF DESCRIPTION OF THE DRAWINGS

FIG. 1A is a top view of a vehicle including an example safety system in accordance with the present invention.

FIG. 1B is a section view taken along line 1B-1B of the vehicle of FIG. 1A.

FIG. 2 is a schematic illustration of various vehicle components connected to a controller.

FIG. 3 is a schematic illustration of an image of an interior of the vehicle when unoccupied.

FIG. 4 is a schematic illustration of an image of an interior of the vehicle when occupied.

FIG. 5 is a schematic illustration of a mobile device held by a user of the vehicle.

### DETAILED DESCRIPTION

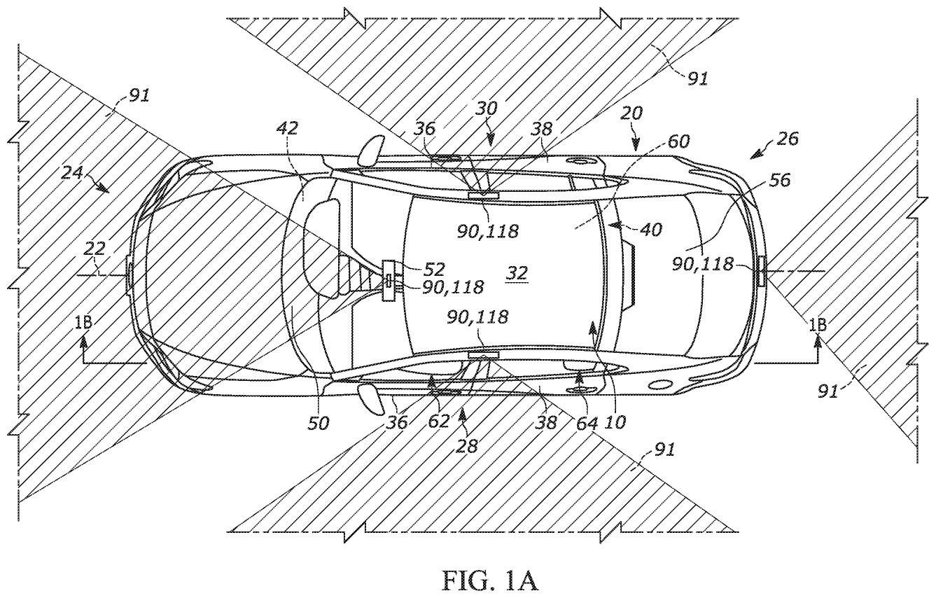

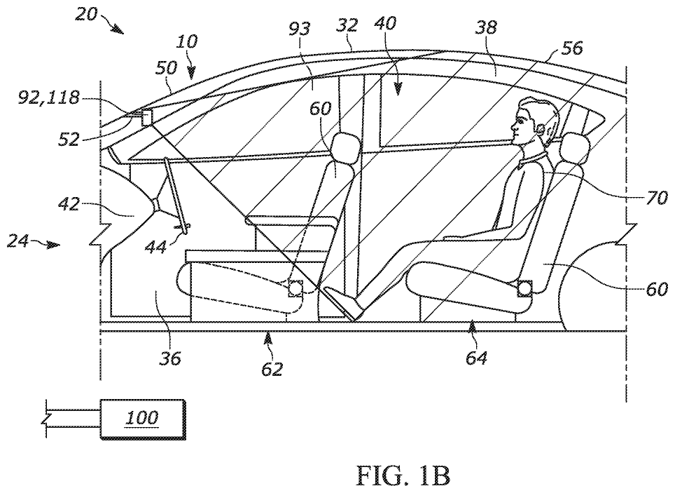

The present invention relates generally to vehicle assist systems, and specifically to a safety system for a vehicle interior. FIGS. 1A-1B illustrate a vehicle 20 having an example vehicle assist system in the form of a vision system 10 for acquiring and processing images within the vehicle. The vehicle 20 extends along a centerline 22 from a first or front end 24 to a second or rear end 26. The vehicle 20 extends to a left side 28 and a right side 30 on opposite sides of the centerline 22. Front and rear doors 36, 38 are provided on both sides 28, 30. The vehicle 20 includes a roof 32 that cooperates with the front and rear doors 36, 38 on each side 28, 30 to define a passenger cabin or interior 40. An exterior of the vehicle 20 is indicated at 41.

The front end 24 of the vehicle 20 includes an instrument panel 42 facing the interior 40. A steering wheel 44 extends from the instrument panel 42. Alternatively, the steering wheel 44 can be omitted (not shown) if the vehicle 20 is an autonomous vehicle. Regardless, a windshield or windscreen 50 is located between the instrument panel 42 and the roof 32. A rear view mirror 52 is connected to the interior of the windshield 50. A rear window 56 at the rear end 26 of the vehicle 20 helps close the interior 40.

The vision system 10 includes at least one camera 90 connected to the vehicle 20 for acquiring images of the exterior 41. As shown, cameras 90 are connected to the front and rear ends 24, 26 as well as the left and right sides 28, 30. Each camera 90 has a field of view 91 extending outward from the vehicle 20 for capturing the vehicle exterior 41.

At least one camera 92 (see FIG. 1B) can be positioned within the vehicle 20 for acquiring images of the interior 40. As shown, a camera 92 is connected to the rear view mirror 52, although other locations, e.g., the roof 32, rear window 56, etc., are contemplated. In any case, the camera 92 has a field of view 93 extending rearward through the interior 40 over a large percentage thereof, e.g., the space between the doors 36, 38 and from the windshield 50 to the rear window 56. The cameras 90, 92 produce signals indicative of the images taken and send the signals to a controller 100. The controller 100, in turn, processes the signals for future use.

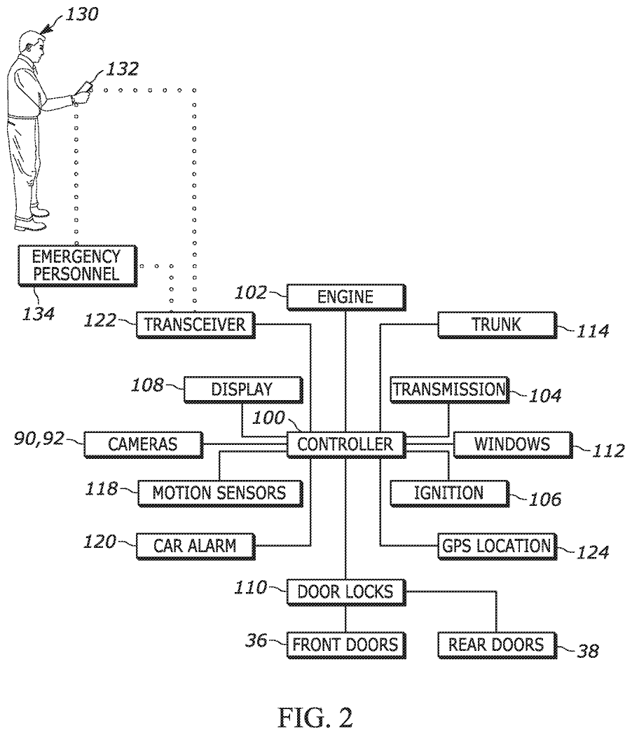

Referring to FIG. 2, the controller 100 can also be connected to multiple components of the vehicle 20. For example, the controller 100 can be connected to the vehicle engine 102, transmission 104, and ignition 106 and receive signals therefrom indicative of the status or condition of each component. The ignition 106 can be a keyed ignition or keyless, e.g., push-button. In any case, the keys can be part of a key fob (not shown). A display 108 on the instrument panel 42 is also connected to the controller 100.

The controller 100 can also be connected to locks 110 associated with the front and rear doors 36, 38, windows 112 provided on the doors, and a trunk 114. The controller 100 receives signals from the locks 110, windows 112, and trunk 114 indicating whether the component is locked, unlocked, open, etc. A car alarm 120 connected to the controller can be configured to activate when any of the doors 36, 38 or trunk 114 is locked and subsequently breached/opened and/or when any of the windows 112 are broken. The car alarm 120 can also be activated in response to any breach or damage to the ignition 106.

One or more motion sensors 118 (see also FIG. 1A) can be connected to the controller 100 for detecting motion in and around the vehicle 20. In one example, the motion sensors 118 are positioned at the same locations on the vehicle 20 as the cameras 90, 92 and have the same fields of view (not shown).

A transceiver 122 is connected to the controller 100 for sending information and/or alerts to a user 130 of the vehicle 20, which will be one of the occupants 70. The user 130 may or may not be the owner of the vehicle 20. The information and/or alerts can be received by, for example, a mobile device 132 or computer accessible to or carried by the user 130. To this end, the mobile device 132 can include an application for receiving, storing, and interacting with information/alerts sent by the transceiver 122. Both the transceiver 122 and the mobile device 132 are capable of sending information to emergency personnel 134, such as police, fire, and EMS services.

A GPS location sensor 124 is connected to the controller 100 for tracking the location of the vehicle 20. The controller 100 can be programmed by the user 130 to store particular locations, e.g., home, work, etc., and the corresponding GPS location.

During operation of the vehicle 20, the user 130 parks the vehicle at an intended location, e.g., parking spot, driveway, garage, etc. The controller 100 receives a signal from the transmission 104 indicating that the vehicle 20 is parked. This can be confirmed by signals received from the motion sensors 118. The user 130—and any other occupants 70—then exit the vehicle 20.

When this occurs, the mobile device 132 can communicate with the controller 100 to determine when the user 130 is a predetermined distance from the vehicle 20. In other words, the GPS location of the mobile device 132 (presumed to be carried by the user 130) is compared to the GPS location of the vehicle 20. The location difference determines when the vehicle 20 is presumed to be unoccupied.

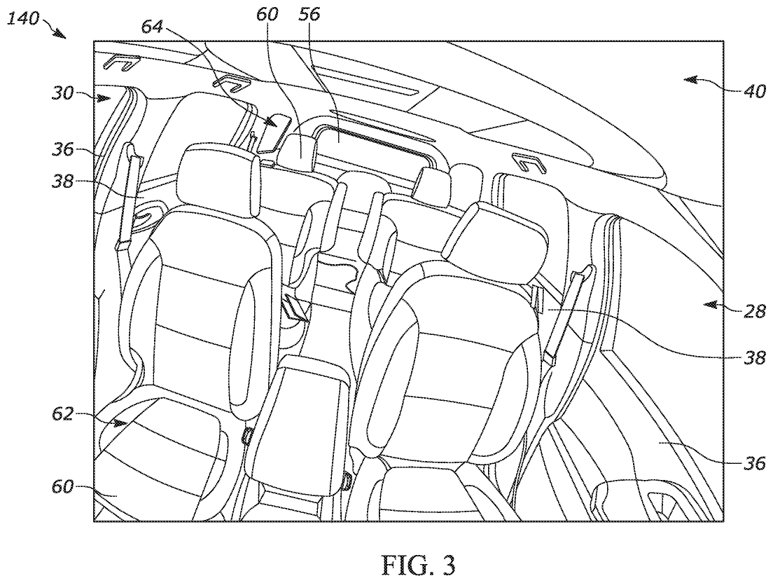

The camera 92 can be used to confirm when the vehicle 20 is unoccupied. To this end, the camera 92 acquires images (herein referred to as “live images”) of the vehicle interior 40 and sends signals to the controller 100 indicative of the images. The controller 100 evaluates the live images and uses image inference to determine if any individuals are located in the vehicle 20. The image inference software is configured such that an individual won't be indicated as detected without at least a predetermined confidence level, e.g., at least 70% confidence an individual is in the live image. An example live image 140 is shown in FIG. 3 and indicates that the vehicle 20 is unoccupied.

The controller 100 can perform several safety-related checks after determining the vehicle 20 is parked and unoccupied. More specifically, the controller 100 can determine whether the vehicle 20 is secure or unsecure by checking, for example, whether the engine 102 is on, if any of the doors 36, 38 are unlocked or open, if any of the windows 112 are open, if the trunk 114 is open, if the keys are left in the ignition 106 and/or if the keys have been left in the unoccupied vehicle 20. The controller 100 can be configured to perform one or more vehicle-related functions in response to determining the unoccupied vehicle 20 is also unsecure. For example, the controller 100 can actuate the door locks 110, roll up the windows 112, and/or lock the trunk 114, if needed, to help increase the safety of the unoccupied vehicle 20.

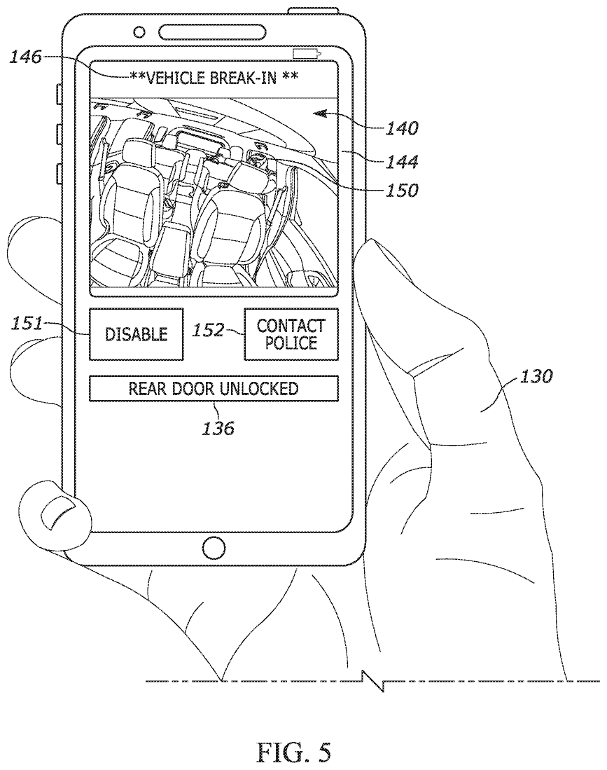

The controller 100 is configured to notify the user 130 when the unoccupied vehicle has one or more unsecure conditions. To this end, the controller 100 can send an alert 136 (see FIG. 5) to the mobile device 132 notifying the user 130 of the unsecure condition(s) and what, if any, remedial measures have been taken. The user 130 can remedy the unsecure conditions by using the application on the mobile device 132. For instance, once the user 130 receives the alert 136 indicating one or more unsecure conditions the user can use the mobile application to close/lock the doors 36, 38, roll up the windows 112, etc. The mobile application can require identification through fingerprint, passcode, etc., before allowing the user 130 to perform these functions.

In certain situations, the user 130 may desire to purposefully leave one or more windows 112 down, e.g., to reduce heat build-up in the vehicle 20. That said, when the mobile application notifies the user 130 that one or more windows 112 are down, the user can interact with the mobile application to instruct the controller 100 not to take any action. In other words, the user 130 can ensure that the window(s) 112 remain down when the vehicle 20 is unoccupied.

With this in mind, the controller 100 or mobile application can retrieve weather data from, for example, an application program interface (API) provided by a weather application. The controller 100 or mobile application can analyze the weather data and use the mobile application to notify the user 130 that inclement weather is ongoing or predicted within a predetermined time around the vehicle 20. In response, the user 130 can interact with the mobile application to either initiate automatic closure of the window(s) 112 or ignore the notification. This can occur, for example, when the vehicle 20 is parked in a garage or covered location.

While the vehicle is unoccupied, the user 130 can also use the mobile device 132 to acquire images, e.g., still images or video, of the vehicle interior 40 and/or exterior 41. To this end, the user 130 can use the mobile application to turn on the cameras 90 and/or camera 92 to acquire images of the vehicle interior 40 or exterior 41. This enables the user 130 to surveil the unoccupied vehicle for any suspicious or untoward activity. The video can be, for example, about 30 seconds long or constitute a live video feed of the vehicle interior 40 and/or exterior 41.

The controller 100 is also configured to alert the user 130 when the unoccupied vehicle 20 is entered and/or broken into. For instance, once the vehicle 20 is deemed unoccupied, any breach of the doors 36, 38, trunk 114, windows 56, 112 or windshield 50 activates the car alarm 120 and alerts the user 130 of the activation. If the user 130 is not already surveilling the vehicle 20, activating the car alarm 120 also causes the cameras 90, 92 to power up and begin acquiring images to send to the user. It will also be appreciated that the cameras 90, 92 can automatically power up and begin image acquisition if the unoccupied vehicle 20 moves, e.g., is raised, pushed, or pulled. The motion sensors 118 can detect such movement and notify the controller 100 accordingly. Such movement can also activate the car alarm 120.

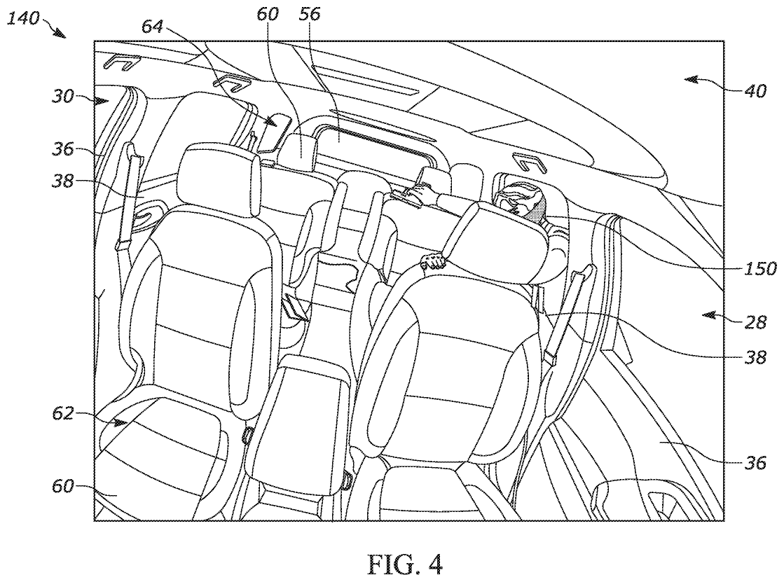

Referring to FIGS. 4-5, in one example, an individual 150 enters the left side 28 of the unoccupied vehicle 20, which activates the car alarm 120. In response, at least one of the live images 140 is sent to the user 130 and shown on a portion 144 of the mobile device 132. An alert 146 is also displayed on the mobile device 132 notifying the user 130 a suspected break-in is occurring.

The user 130 can inspect the live image 140 and make a determination whether the entry of the unoccupied vehicle 20 by the individual 150 is authorized. For example, the user 130 can inspect the live image 140 and determine if the individual 150 is in fact entering the vehicle 20 as opposed to walking past. The user 130 can also determine whether or not the individual 150 is authorized to enter the vehicle 20. If the individual 150 is deemed authorized, the user 130 can disregard the alert 146 and touch a “DISABLE” icon 151 on the mobile device 132. This would deactivate the car alarm 120 and can terminate the live image 140 feed to the mobile device 132.

If, however, the individual 150 is deemed unauthorized, the user 130 can touch a “CONTACT POLICE” icon 152 on the mobile device 132. This causes the mobile device 132 to call the nearest police station based on the GPS location of the vehicle 20. At the same time, the controller 100 can send images/video of the suspected break-in to the emergency personnel 134.

The controller 100 can also send an alert to the user 130 when the cameras 90, 92 and/or motion sensors 118 indicate that an individual is within a predetermined distance from the unoccupied vehicle 20. The user 130 can then examine the live images 140 to determine whether an individual is, in fact, in close proximity to the vehicle and make a determination whether that individual is authorized to be in close proximity to the vehicle. In response, the user 130 can activate the car alarm 120 (if the activity of the individual looks suspicious) or take no action (if the activity of the individual does not look suspicious).

It will be appreciated that the user 130 can configure the safety system 10 to automatically surveil the unoccupied vehicle 20 based on predefined user settings, such as the GPS location, time of day, proximity of an individual to the vehicle 20, etc. The automatic surveillance can include automatically sending images to the mobile device 132 or only sending images when one or more predefined conditions are met, e.g., detection of an individual in the vehicle 20, car alarm 120 activation, etc. Consequently, the safety system 10 of the present invention can be tailored to meet the specific needs of the user/owner 130.

The safety system of the present invention is advantageous in that it enables an user/owner of a vehicle to be notified of unsecure conditions and remedy those conditions remotely. The safety system also allows a remote-located user/owner to surveil the vehicle, make determinations whether untoward activity is happening in/around the vehicle, and notify emergency personnel, if desired.

What have been described above are examples of the present invention. It is, of course, not possible to describe every conceivable combination of components or methodologies for purposes of describing the present invention, but one of ordinary skill in the art will recognize that many further combinations and permutations of the present invention are possible. Accordingly, the present invention is intended to embrace all such alterations, modifications and variations that fall within the spirit and scope of the appended claims.

What is claimed is:

1. A method of monitoring a vehicle, comprising:
determining the vehicle is in a parked condition;
determining the parked vehicle is unoccupied;
acquiring images of the unoccupied vehicle; and
sending at least one of the acquired images to a user of the vehicle in response to detecting an individual at the unoccupied vehicle.

2. The method recited in claim 1, wherein the step of sending at least one of the acquired images comprises sending a still image of the vehicle interior including the individual.

3. The method recited in claim 1, wherein the step of sending at least one of the acquired images comprises sending a still image of the vehicle exterior including the individual.

4. The method recited in claim 1, wherein the step of sending at least one of the acquired images comprises sending a video of the vehicle interior including the individual.

5. The method recited in claim 1, wherein the step of sending at least one of the acquired images comprises sending a video of the vehicle exterior including the individual.

6. The method recited in claim 1, further comprising allowing the user to examine the at least one acquired image to determine if the individual is authorized or unauthorized.

7. The method recited in claim 6, further comprising alerting emergency personnel in response to the user determining the individual is unauthorized.

8. The method recited in claim 1, wherein the at least one acquired image is sent to the user in response to detecting in the acquired images an individual entering the unoccupied vehicle.

9. The method recited in claim 1, wherein the at least one acquired image is sent to the user in response to a car alarm activation detecting an individual at the unoccupied vehicle.

10. The method recited in claim 1, further comprising:
identifying at least one unsecure condition in the unoccupied vehicle; and
notifying the user of the at least one unsecure condition.

11. The method recited in claim 10, further comprising providing the user a choice whether to remedy the at least one unsecure condition from a mobile device.

12. The method recited in claim 11, further comprising automatically remedying the at least one unsecure condition in response to the user choice.

13. The method recited in claim 10, wherein the at least one unsecure condition comprises an unlocked or open door.

14. The method recited in claim 10, wherein at least one unsecure condition comprises an open window.

15. The method recited in claim 14, further comprising:
analyzing weather data around the vehicle;
notifying the user of the weather data; and
providing the user a choice whether to close the open window from a mobile device.

16. The method recited in claim 10, wherein the at least one unsecure condition comprises an unlocked or open trunk.

17. The method recited in claim 10, wherein the at least one unsecure condition comprises a running engine.

18. The method recited in claim 10, wherein the at least one unsecure condition comprises keys left in the ignition.

19. The method recited in claim 10, wherein the at least one unsecure condition comprises keys left in the vehicle.

20. A method of monitoring a vehicle, comprising:
determining the vehicle is in a parked condition;
determining the parked vehicle is unoccupied;
identifying at least one unsecure condition in the unoccupied vehicle; and
notifying the user of the at least one unsecure condition.

21. The method recited in claim 20, further comprising providing the user a choice whether to remedy the at least one unsecure condition from a mobile device.

22. The method recited in claim 20, further comprising automatically remedying the at least one unsecure condition in response to the user choice.

23. The method recited in claim 20, wherein the at least one unsecure condition comprises an unlocked or open door.

24. The method recited in claim 20, wherein at least one unsecure condition comprises an open window.

25. The method recited in claim 24, further comprising:
analyzing weather data around the vehicle;
notifying the user of the weather data; and
providing the user a choice whether to close the open window from a mobile device.

26. The method recited in claim 20, wherein the at least one unsecure condition comprises an unlocked or open trunk.

27. The method recited in claim 20, wherein the at least one unsecure condition comprises a running engine.

28. The method recited in claim 20, wherein the at least one unsecure condition comprises keys left in the ignition.

29. The method recited in claim 20, wherein the at least one unsecure condition comprises keys left in the vehicle.
